(19) United States
(12) Patent Application Publication
(10) Pub. No.: US 2008/0094982 A1
(43) Pub. Date: Apr. 24, 2008

(54) Tracking Error Signal Calibration Method, and Disc Drive Implementing Such Method

(75) Inventor: Hendrikus C.M. Van Der Heijden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,581

(22) PCT Filed: Jul. 1, 2005
(86) PCT No.: PCT/IB05/52192

§ 371 Date: Jan. 3, 2007

(30) Foreign Application Priority Data
Jul. 14, 2004 (EP) 04103371.3

(51) Int. Cl. G11B 7/09; G11B 7/125; G11B 20/18

(52) U.S. Cl. 369/53.29

(57) ABSTRACT

A method for generating a calibration value (TESC) for a tracking error signal (TES) in an optical disc drive (1) comprises the steps of performing a jump towards a target track of an optical disc (2) inserted in said optical disc drive (1); during at least a part of the jump, calculating the calibration value (TESC) as an approximation of the average of a plurality of tracking error signal amplitudes (TESA(i)) corresponding to a plurality of track crossings.

### FIELD OF THE INVENTION

The present invention relates in general to a disc drive apparatus for writing/reading information into/from an optical storage disc; hereinafter, such disc drive apparatus will also be indicated as “optical disc drive”.

More particularly, the present invention relates to e method for calibration and normalization of the tracking error signal.

### BACKGROUND OF THE INVENTION

As is commonly known, an optical storage disc comprises at least one track, either in the form of a continuous spiral or in the form of multiple concentric circles, of storage space where information may be stored in the form of a data pattern. Optical discs may be read-only type, where information is recorded during manufacturing, which information can only be read by a user. An optical storage disc may also be a writable type, where information may be stored by a user. For writing information in the storage space of the optical storage disc, or for reading information from the disc, an optical disc drive comprises, on the one hand, rotating means for receiving and rotating an optical disc, and on the other hand optical scanning means. Since the technology of optical discs in general, the way in which information can be stored in an optical disc, and the way in which optical data can be read from an optical disc, is commonly known, it is not necessary here to describe this technology in more detail.

For rotating the optical disc, an optical disc drive typically comprises a motor, which drives a hub engaging a central portion of the optical disc. Usually, the motor is implemented as a spindle motor, and the motor-driven hub may be arranged directly on the spindle axle of the motor.

For optically scanning the rotating disc, an optical disc drive comprises a light beam generator device (typically a laser diode), means (such as an objective lens) for focussing the light beam in a focal spot on the disc, and an optical detector for receiving the reflected light reflected from the disc and for generating an electrical detector output signal. The optical detector usually comprises multiple detector segments, each segment providing an individual segment output signal.

During operation, the light beam should remain focussed on the disc. To this end, the objective lens is arranged axially displaceable, and the optical disc drive comprises focal actuator means for controlling the axial position of the objective lens. Further, the focused light spot should remain aligned with a track or should be capable of being displaced from a current track to a new track. To this end, at least the objective lens is mounted radially displaceable, and the optical disc drive comprises radial actuator means for controlling the radial position of the objective lens.

For track following, i.e. for keeping the beam focus point aligned with a track, the optical disc drive comprises a radial servo system, capable of determining any deviation between actual focus position and desired focus position, indicated as tracking error, and to control the radial position of the focus point such said tracking error is as small as possible, preferably zero. A control circuit receives the electrical detector output signal, and derives therefrom a tracking error signal, representing the actual value of the tracking error. On the basis of this tracking error signal, the control circuit generates a control signal for the radial actuator. Since tracking error signals, and radial servo systems using such tracking error signals as input signals, are known per se, it is not necessary here to explain this in large detail.

Ideally, the tracking error signal is a function of the actual value of the tracking error only, i.e. for the same value of a tracking error, the tracking error signal always has the same signal value. In practice, however, this is not the case: for several reasons, the relationship between tracking error and tracking error signal may vary over the surface of a storage disc. In order to obtain a predictable servo system, it is desirable that the same tracking error results in the same servo action, thus it is desirable that the control circuit receives or calculates a tracking error signal which is not, or at least less, sensitive to variations of said relationship.

To this end, it is known to perform, in an initialization stage, a plurality of calibration procedures in respect of a predetermined number of predefined disc zones (radial portions of the storage space). In each disc zone, the amplitude of the tracking error signal is measured, and the measured amplitude is stored in a memory. Later, in operation, a measured tracking error signal is compared to the stored tracking error signal amplitude of the corresponding zone in order to obtain a normalized tracking error signal, and a radial control signal for the radial actuator is generated on the basis of the normalized tracking error signal.

The concept of using a normalized tracking error signal works quite well. However, a disadvantage of this known process of dividing the disc into a plurality of zones and performing calibration procedures (tracking error signal amplitude measurements) in each of those zones, during the start-up phase of the disc, is that it is rather time consuming: each measurement may take about 200 ms, and the number of zones may be in the order of about 10. This adds to the time a user must wait before he can use the disc.

A further problem is that a compromise must be found between the desire of reduced time consumption during initialization and the desire of improved accuracy. The duration of the initialization process can be reduced by reducing the number of zones, but the pay-off is that the size of the zones increases and the tracking error signal amplitude as measured is less accurate for the entire zone.

In an attempt to solve these problems, U.S. Pat. No. 5,504,726 has already proposed to measure the tracking error signal amplitude during track jumping. According to this publication, the tracking error signal amplitude is determined as being the maximum amplitude as measured during a large jump with a plurality of track crossings, or as being the maximum amplitude as measured during three successive one-track jumps.

A disadvantage of the method proposed by U.S. Pat. No. 5,504,726 is that the method is very sensitive to disc imperfections such as scratches. A scratch may have an effect that the amplitude of the tracking error signal is reduced or increased as compared to the “normal” value, i.e. the value which the amplitude of the tracking error signal would have had without the presence of such scratch. Since, in the known method, the tracking error signal amplitude to be used for normalization (hereinafter also indicated as “calibration amplitude”) is actually the amplitude corresponding to one track crossing, namely the one track crossing with the largest amplitude, it is very likely that, in the case of a scratch, a “wrong” amplitude is taken as the calibration amplitude.

An important objective of the present invention is to provide a calibration method where the above problem is eliminated or at least reduced.

More specifically, the present invention aims to provide a calibration method which is less sensitive to scratches.

### SUMMARY OF THE INVENTION

According to an important aspect of the present invention, a jump is performed over a plurality of tracks, and the individual tracking error signal amplitude is measured for each individual track crossing. A calibration amplitude is calculated on the basis of a plurality of such individual tracking error signal amplitudes. Thus, the measured tracking error signal amplitude of each track crossing contributes to the calibration amplitude. Errors in an individual tracking error signal amplitude, for instance caused by scratches, have less influence on the value of the calibration amplitude.

Preferably, the calibration amplitude is calculated on the basis of a plurality of tracking error signal amplitudes measured while crossing tracks with a constant speed.

In a possible embodiment, the calibration amplitude is calculated as the average of all contributing tracking error signal amplitudes.

In a preferred embodiment, the calibration amplitude is calculated by increasing the calibration amplitude if a new track crossing provides a tracking error signal amplitude larger than the current calibration amplitude, and by decreasing the calibration amplitude if a new track crossing provides a tracking error signal amplitude smaller than the current calibration amplitude. The value of increase and the value of decrease may be constant, but they may also be proportional to the difference between current tracking error signal amplitude and current calibration amplitude.

### BRIEF DESCRIPTION OF THE DRAWINGS

These and other aspects, features and advantages of the present invention will be further explained by the following description with reference to the drawings, in which same reference numerals indicate same or similar parts, and in which:

FIG. 1 schematically illustrates relevant components of an optical disc drive apparatus;

FIG. 2A is a graph schematically illustrating a characteristic TES curve during consecutive track crossings.

FIG. 2B is a graph similar to FIG. 2A, on a larger time-scale, illustrating a possible disturbance situation;

FIG. 3 is a flow diagram illustrating a calibration method;

FIG. 4 is a block diagram of a processing circuit for implementing the method of FIG. 3;

FIG. 5 is a schematic graph illustrating the general shape of a tracking error signal;

FIG. 6 is a graph showing the tracking error signal during an actual jump;

FIG. 7 is a graph schematically illustrating a jump profile;

FIG. 8 is a block diagram schematically illustrating the normalization of the tracking error signal.

### DETAILED DESCRIPTION OF THE INVENTION

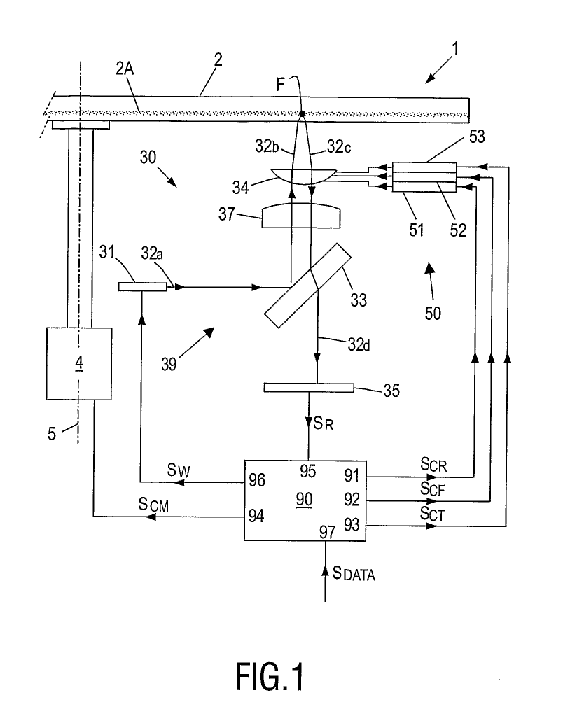

FIG. 1 schematically illustrates an optical disc drive apparatus 1, suitable for storing information on and reading information from an optical disc 2, typically a DVD or a CD. The disc 2, of which the thickness is shown in an exaggerated way, has at least one storage layer 2A. For rotating the disc 2, the disc drive apparatus 1 comprises a motor 4 fixed to a frame (not shown for the sake of simplicity), defining a rotation axis 5.

The disc drive apparatus 1 further comprises an optical system 30 for scanning tracks (not shown) of the disc 2 by an optical beam. More specifically, in the exemplary arrangement illustrated in FIG. 1, the optical system 30 comprises a light beam generating means 31, typically a laser such as a laser diode, arranged to generate a light beam 32. In the following, different sections of the light beam 32, following an optical path 39, will be indicated by a character a, b, c, etc. added to the reference numeral 32.

The light beam 32 passes a beam splitter 33, a collimator lens 37 and an objective lens 34 to reach (beam 32b) the disc 2. The light beam 32b reflects from the disc 2 (reflected light beam 32c) and passes the objective lens 34, the collimator lens 37 and the beam splitter 33 (beam 32d) to reach an optical detector 35. The objective lens 34 is designed to focus the light beam 32b in a focus spot F on the storage layer 2A.

The disc drive apparatus 1 further comprises an actuator system 50, which comprises a radial actuator 51 for radially displacing the objective lens 34 with respect to the disc 2. Since radial actuators are known per se, while the present invention does not relate to the design and functioning of such radial actuator, it is not necessary here to discuss the design and functioning of a radial actuator in great detail.

For achieving and maintaining a correct focusing, exactly on the desired location of the disc 2, said objective lens 34 is mounted axially displaceable, while further the actuator system 50 also comprises a focus actuator 52 arranged for axially displacing the objective lens 34 with respect to the disc 2. Since focus actuators are known per se, while further the design and operation of such focus actuator is no subject of the present invention, it is not necessary here to discuss the design and operation of such focus actuator in great detail.

For achieving and maintaining a correct tilt position of the objective lens 34, the objective lens 34 may be mounted slantingly; in such case, as shown, the actuator system 50 also comprises a tilt actuator 53 arranged for pitching the objective lens 34 with respect to the disc 2. Since tilt actuators are known per se, while further the design and operation of such tilt actuator is no subject of the present invention, it is not necessary here to discuss the design and operation of such tilt actuator in great detail.

It is further noted that means for supporting the objective lens with respect to an apparatus frame, and means for axially and radially displacing the objective lens, as well as means for pitching the objective lens, are generally known per se. Since the design and operation of such supporting and displacing means are no subject of the present invention, it is not necessary here to discuss their design and operation in great detail.

It is further noted that the radial actuator 51, the focus actuator 52 and the tilt actuator 53 may be implemented as one integrated actuator.

The disc drive apparatus 1 further comprises a control circuit 90 having a first output 91 coupled to a control input of the radial actuator 51, having a second output 92 coupled to a control input of the focus actuator 52, having a third output 93 coupled to a control input of the tilt actuator 53, having a fourth output 94 coupled to a control input of the motor 4, and having a fifth output 96 coupled to a control input of the laser device 31. The control circuit 90 is designed to generate at its first output 91 a control signal S_{CR} for controlling the radial actuator 51, to generate at its second control output 92 a control signal S_{CF} for controlling the focus actuator 52, to generate at its third output 93 a control signal S_{CT} for controlling the tilt actuator 53, to generate at its fourth output 94 a control signal S_{CM} for controlling the motor 4, and to generate at its fifth output 96 a control signal S_{W} for controlling the laser.

The control circuit 90 further has a read signal input 95 for receiving a read signal S_{R} from the optical detector 35. The optical detector 35 may actually comprise several individual detector elements, as is known per se, and the read signal S_{R} may actually consist of several individual detector element output signals, as is also known per se. Further, the read signal input 95 may actually comprise several individual input signal terminals, each one receiving a corresponding one of the detector element output signals, as is also known per se.

The control circuit 90 is designed to process individual detector element output signals to derive one or more error signals. A radial error signal or tracking error signal, designated hereinafter simply as TES, indicates the radial distance between a track and the focus spot F. A focus error signal, designated hereinafter simply as FES, indicates the axial distance between the storage layer and the focus spot F. It is noted that, depending on the design of the optical detector, different formulas for error signal calculation may be used.

In a reading mode, the intensity of the laser beam 32 is kept substantially constant, and variations in intensity of the individual detector element output signals received at the read signal input 91 reflect the data content of the track being read. The control circuit 90 further comprises a data input 97. In a writing mode, the control circuit 90 generates a control signal S_{W} for the laser 31 on the basis of a data signal S_{DATA} received at its data input 97, so that the laser beam intensity fluctuates for writing a pattern corresponding to the input data. Distinct intensity levels are also used for erasing a rewritable disc, which may take place while overwriting the existent data or as a stand-alone process that blanks the disc.

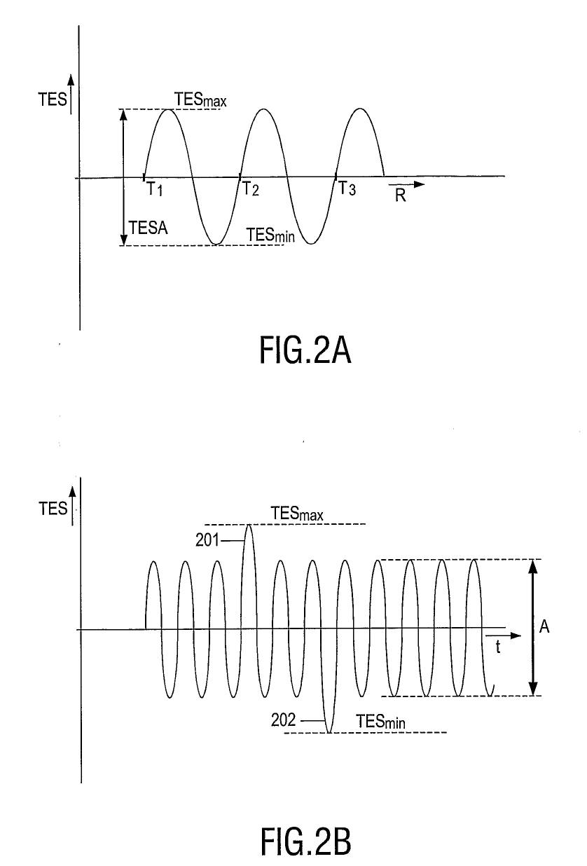

FIG. 2A is a graph schematically illustrating the behaviour of TES when the disc drive apparatus 1 performs a jump, i.e. when the focus spot F is displaced radially to go to a certain target track. During the travel towards the target track, the focus spot F crosses tracks; at each track crossing, indicated T1, T2, T3 in FIG. 2A, TES becomes zero. After having passed a track, TES reaches a maximum positive value TESmax and a maximum negative value TESmin before crossing the next track. The graphical representation of the TES behaviour is indicated as characteristic TES curve; it is noted that the shape of such characteristic TES curve is known to a person skilled in the art, and needs no further explanation.

The control circuit 90 is designed to generate its actuator control signals as a function of the error signals, to reduce the corresponding error, as will be clear to a person skilled in the art. However, due to variations in disc parameters, the value of TES for a certain tracking error may be different in different locations on the disc, and as a consequence, the value of TES per se is not a good indication of the actual value of the tracking error. It is possible to derive a normalised tracking error signal, indicated hereinafter as TESN, in accordance with formula (1):

TESN=TES/TESA (1)

wherein TESA is a value representing the amplitude of TES according to formula (2):

TESA=TESmax−TESmin (2)

Local variations will have a similar influence on both TES and TESA, so that TESN will be independent from such local variations.

FIG. 2B is a graph similar to FIG. 2A, on a different time-scale, illustrating a problem of prior art for a case where a normalised tracking error signal is calculated in accordance with formula (1), and where the amplitude of TES, according to formula (2), is calculated by performing a jump and looking for the maximum and minimum values of TES. FIG. 2B shows a TES curve corresponding to a larger number of track crossings, wherein the amplitude is practically constant. However, due to imperfections such as scratches, the curve shows a positive peak 201 having excessive peak value TESmax, and shows a negative peak 202 having excessive peak value TESmin. It should be clear that the value TESA as calculated with formula (2) does not correspond to the actual amplitude as indicated at A.

According to the present invention, this problem is avoided or at least reduced when the control circuit 90 uses a normalised tracking error signal TESN in accordance with formula (3):

TESN=TES/TESC (3)

wherein TESC is a calibration value calculated on the basis of a plurality of track crossing signals, i.e. a plurality of track crossings contribute to the calibration value TESC.

In the following, if a value X is a function of N measurements m1, m2, m3, . . . mN, this may be indicated as X=f(m1, m2, m3, . . . mN), but it is briefly indicated as X=f[i=1 to N](m{i}).

Preferably, the function f is an averaging function according to

$$f [ i = 1 to N ] ( m \{ i \} ) = \frac{1}{N} {\sum }_{i = 1}^{N} m \{ i \} \qquad ( 4 )$$

but f may also be a function which results in a good approximation of an average.

When calculating TESC, it is possible to use the amplitude A{i} corresponding with each track crossing, and to calculate TESC according to TESC=f[i=1 to N](A{i}). Preferably, however, TESC is calculated according to

TESC=f[i=1 to N](TESmax{i})−f[i=1 to N](TESmin{i}) (5)

In other words, it is preferred to first calculate a calibration maximum Cmax according to

Cmax=f[i=1 to N](TESmax{i}) (6)

and a calibration minimum Cmin according to

Cmin=f[i=1 to N](TESmin{i}) (7)

and to then calculate TESC according to TESC=Cmax−Cmin.

As mentioned, Cmax and Cmin preferably are a good approximation of the average of TESmax(i) and TESmin(i), respectively. It is possible to actually measure TESmax(i) and TESmin(i), respectively, and to calculate Cmax and Cmin on the basis of the last N actually measured values of TESmax(i) and TESmin(i), N being a predefined number. With “the last N values” is meant the values corresponding to the last N track crossings before the end of the jump.

However, using actually measured values would require 2N memory locations, and a procedure for updating these memory locations at each track crossing. Further, it would require a circuit capable of determining reliably when the tracking error signal has reached a maximum/minimum value. Therefore, the present invention also provides a preferred calibration procedure for generating Cmax and Cmin as approximation of the average of TESmax(i) and TESmin(i), respectively, as will be explained in the following.

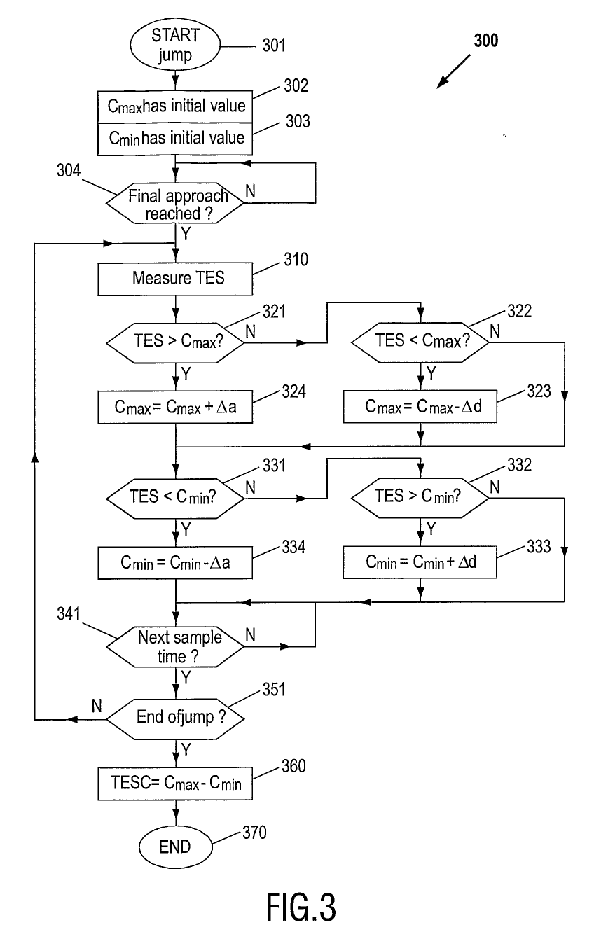

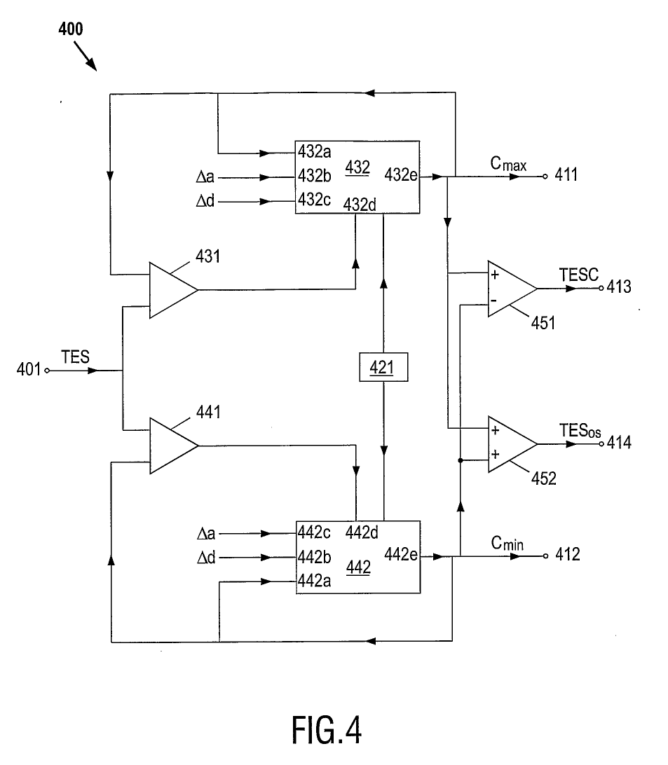

FIG. 3 is a flow diagram of an embodiment of a preferred calibration method 300 for calculating TESC, and FIG. 4 is a block diagram of a processing circuit 400, part of the control circuit 90, for implementing the method.

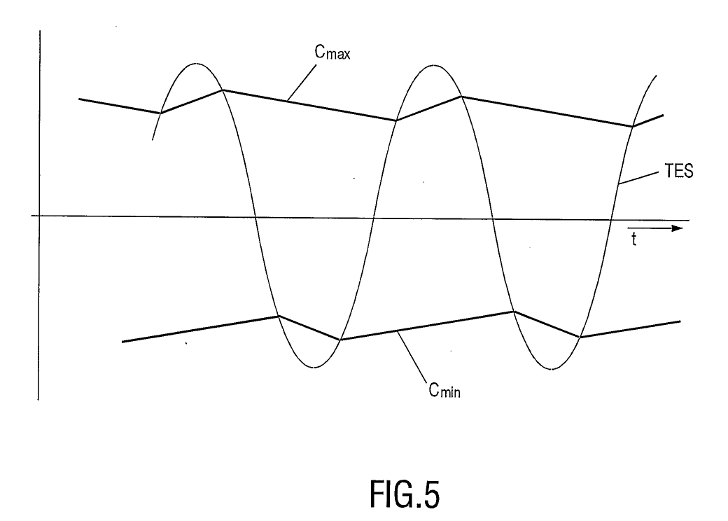

The processing circuit 400 has a signal input 401 for receiving the tracking error signal TES, and outputs 411, 412, 413 and 414 for providing a calibration maximum Cmax output signal, a calibration minimum Cmin output signal, a calibration value TESC output signal, and an offset TESos output signal, respectively. FIG. 5 is a graph showing, by way of example, a possible tracking error signal TES and the corresponding calibration maximum Cmax and calibration minimum Cmin as a function of time.

The processing circuit 400 comprises a clock signal generator 421, generating a clock signal Sc having a frequency well above the largest track crossing frequency to be expected; in an suitable embodiment, the clock signal frequency was 128 kHz.

The processing circuit 400 further comprises a first comparator 431. At a first input terminal, the first comparator 431 receives the tracking error signal TES from input 401, and at a second input terminal, the comparator 431 receives the calibration maximum signal Cmax from output 411.

The processing circuit 400 further comprises a first controllable adder 432, which has an output terminal 432e coupled to output terminal 411 and to the second input terminal of the comparator 431 for providing the output signal Cmax. The controllable adder 432 has a first input 432a receiving the output signal Cmax. The controllable adder 432 has a second input 432b receiving a predetermined addition value Δa, and has a third input 432c receiving a predetermined subtraction value Δd. The controllable adder 432 has a control input 432d receiving an output signal from the comparator 431.

During operation of the disc drive 1, when a jump is performed, the calibration method 300 is executed. Preferably, the calibration method 300 is executed during each jump.

At the start of the jump [step 301], Cmax and Cmin have initial values Cmax,i and Cmin,i, respectively [steps 302 and 303]. These initial values may be predetermined fixed values, always to be used at the start of a jump. It is also possible that the disc drive memorizes Cmax and Cmin for several radial zones and, if the jump is to be made towards a target track in a zone which has already been accessed by the disc drive, that the disc drive takes the memorized values as initial values. However, the simplest and therefore preferred way is to keep Cmax and Cmin constant between jumps, so that Cmax,i and Cmin,i, respectively, correspond to the values of Cmax and Cmin, respectively, as measured in the previous jump.

The calculation of Cmax and Cmin may start immediately after start of the jump. However, the calculation of Cmax and Cmin is preferably only executed in relation to a final approach stage of the jump [step 304]. The jump is preferably executed such that the track crossing speed is constant during this final approach stage, as will be explained later.

During the final approach stage, the comparator 431 receives the tracking error signal TES [step 310] and compares TES with the current value of Cmax [step 321, 322]. At sample moments, determined by the clock signal Sc, the controllable adder 432 analyses the output signal from the comparator 431, and, depending on the result of the analysis, increases its output signal Cmax by the predetermined addition value Δa or decreases the output signal Cmax by the predetermined subtraction value Δd. More particularly, if the output signal from the comparator 431 indicates that the input signal TES is larger than the current output signal Cmax, the adder 432 adds [step 324] the value Δa received at its second input 432b to the value Cmax currently received at its first input 432a, and provides the result as next output signal Cmax at its output terminal 432e. On the other hand, if the output signal from the comparator 431 indicates that the input signal TES is smaller than the current output signal Cmax, the adder 432 subtracts [step 323] the value Δd received at its third input 432c from the value Cmax currently received at its first input 432a, and provides the result as next output signal Cmax at its output terminal 432e. If the input signal TES is equal to the current output signal Cmax, Cmax is left unchanged.

Thus, as long as TES>Cmax, the value Cmax is stepwise increased by steps Δa at the sample moments, whereas, as long as TES<Cmax, the value Cmax is stepwise decreased by steps Δd at the sample moments. Since the sample frequency is larger than the track crossing frequency, the value Cmax “constantly” rises at a rate determined by Δa as long as TES>Cmax, and the value Cmax constantly decreases at a rate determined by Δd as long as TES<Cmax; the resulting behaviour of Cmax is illustrated in FIG. 5.

It should be clear that, at any moment, the current output value Cmax depends on the historic development of TES over a plurality of track crossings, and approaches the true average of TESmax. It should further be clear that an individual anomaly of a TES maximum, for instance caused by a scratch, has a reduced influence on the eventual output signal Cmax.

Likewise, the processing circuit 400 comprises a second comparator 441, which compares [step 331, 332] the tracking error signal TES with the current value of the calibration minimum output signal Cmin, and a second controllable adder 442, receiving as input signals the calibration minimum output signal Cmin, the predetermined value Δa as subtraction value, and the predetermined value Δd as addition value. Also, the second controllable adder 442 has a control input 442d receiving an output signal from the second comparator 441.

At the sample moments, the second controllable adder 442 analyses the output signal from the second comparator 441. If the output signal from the second comparator 441 indicates that the input signal TES is lower than the output signal Cmin, the second adder 442 subtracts [step 334] the subtraction value Δa from the current value of Cmin and provides the result as next output signal Cmin at its output terminal 442e. On the other hand, if the output signal from the second comparator 441 indicates that the input signal TES is higher than the output signal Cmin, the second adder 442 adds [step 333] the addition value Δd to the current value of Cmin and provides the result as next output signal Cmin at its output terminal 442c. If the input signal TES is equal to the current output signal Cmin, Cmin is left unchanged. The resulting behaviour of Cmin is also illustrated in FIG. 5.

The above is repeated at a next sample time [step 341], until the end of the jump (i.e. the target track) has been reached [step 351]. Then, the calibration value TESC is calculated [step 360], and the calibration process ends [step 370]. To that end, the processing circuit 400 further comprises a subtractor 451, receiving the output signals Cmax and Cmin and arranged to provide the difference signal Cmax−Cmin at its output 413, which corresponds to the calibration value TESC.

Preferably, and as illustrated, the processing circuit 400 further comprises an adder 452, also receiving the output signals Cmax and Cmin and arranged to provide the sum signal Cmax+Cmin at its output 414, which corresponds to an offset value TESos. Taking into account that, normally, Cmin<0, TESos should normally be approximately zero.

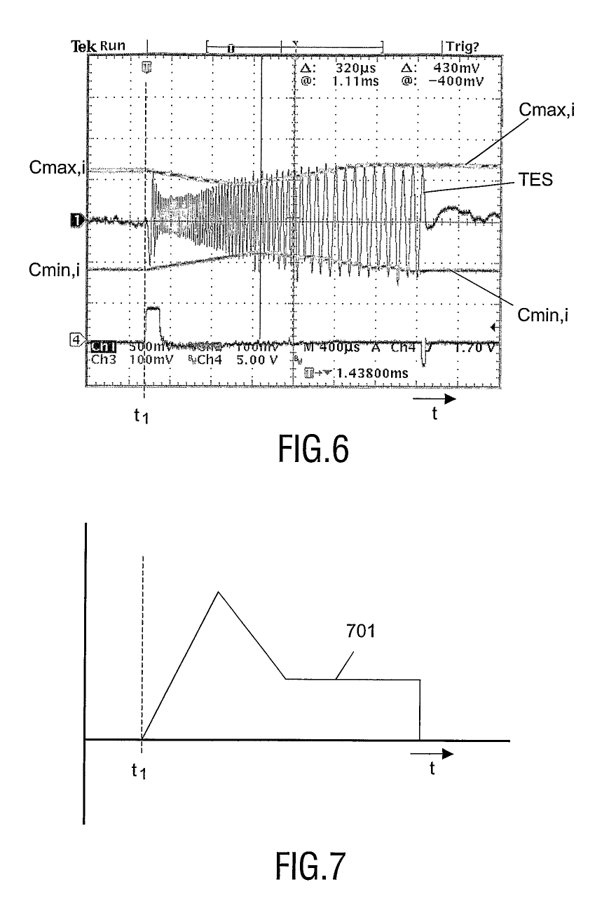

FIG. 6 is a graph, obtained as an oscilloscope picture, showing the tracking error signal TES during an actual jump. Cmax and Cmin are also shown. FIG. 7 is a graph, schematically illustrating the jump profile, i.e. track crossing speed as a function of time.

At time t1, the jump is initiated; at that moment, the controllable adders 432 and 442 are set at predetermined initial values, which may be the corresponding values obtained at the end of the previous jump.

At first, the track crossing speed increases to reach a maximum, and then decreases to reach a constant value. The final approach of the target track is performed with this constant track crossing speed, indicataed at 701, and involves a plurality of track crossings, preferably 10 or more.

In FIG. 6, it can be seen that, in a first stage of the jump, the TES amplitude is relatively small, causing the absolute values of Cmax and Cmin to decrease. During the final approach of the jump, Cmax and Cmin approach more or less constant values, which are a good approximation of the average of the positive and negative peak values of TES, respectively, and which are hardly influenced by an occasional anomaly.

Tests have shown that the system as described above functions reliably. It is to be noted that the actual values of Δa and Δd have an influence on the overall behaviour of the system, and should be suitably set in relationship to the amplitude of TES to be expected, and in relationship to the sample frequency and the track crossing frequency to be expected in the final approach stage of the jumps.

Normally, it is to be preferred that Δa is larger than Δd, the ratio Δa/Δd preferably being in the order of at least five or higher, more preferably in the order of 10.

In a test arrangement, the track crossing frequency in the final approach stage of the jumps was set to approximately 10 kHz, and the sample frequency was set to 128 kHz. The tracking error signal was measured using an A/D converter, which was set such that the amplitude of TES in the final approach stage of the jumps normally corresponded to a digital value in the order of about 8000. In this experiment, under the conditions as described, suitable values for Δa and Δd appeared to be Δa≈100 and Δd≈10.

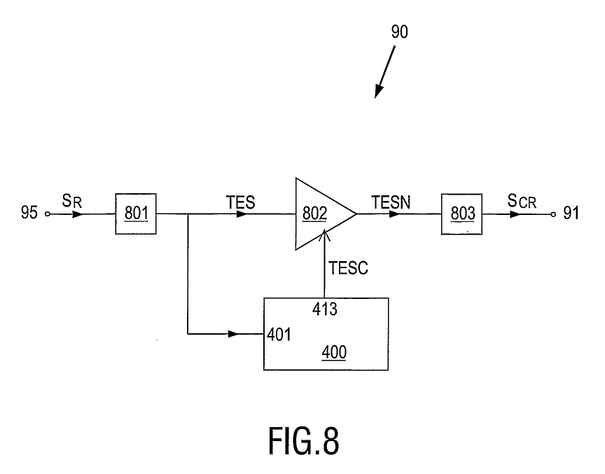

FIG. 8 is a block diagram schematically illustrating how the control circuit 90 generates a control signal S_{CR} for the radial actuator 51 during track following. A TES calculating block 801 receives the detector output S_{R}, and calculates the tracking error signal TES according to a predefined formula. A controllable gain amplifier 802 receives the TES as input signal, and receives the calibration value TESC from the processing circuit 400. The controllable gain amplifier 802 sets its gain such that a normalized output signal TESN is generated, equal to or proportional to TES/TESC. The control signal S_{CR} is generated by a further processing block 803 on the basis of the normalized tracking error signal TESN.

If desired, the further processing block 803 may take into account the offset signal TESos generated by the processing circuit 400, but this is not illustrated in FIG. 8.

It should be clear to a person skilled in the art that the present invention is not limited to the exemplary embodiments discussed above, but that several variations and modifications are possible within the protective scope of the invention as defined in the appending claims.

For instance, it is possible that Δa and Δd are adjustable.

Further, in the above embodiment, the addition value for Cmax is equal to the subtraction value for Cmin (Δa), but this is not essential. The same applies to the subtraction value for Cmax and the addition value for Cmin (Δd).

In the above, the present invention has been explained with reference to block diagrams, which illustrate functional blocks of the device according to the present invention. It is to be understood that one or more of these functional blocks may be implemented in hardware, where the function of such functional block is performed by individual hardware components, but it is also possible that one or more of these functional blocks are implemented in software, so that the function of such functional block is performed by one or more program lines of a computer program or a programmable device such as a microprocessor, microcontroller, digital signal processor, etc.

1. Method for generating a calibration value (TESC) for a tracking error signal (TES) in an optical disc drive (1), comprising the steps of:
performing a jump towards a target track of an optical disc (2) inserted in said optical disc drive (1);
during at least a part of the jump, generating the calibration value (TESC) depending on a plurality of tracking error signal amplitudes (TESA(i)) corresponding to a plurality of track crossings.

2. Method according to claim 1, wherein the jump has a final approach stage with a substantial constant track crossing speed (701), and wherein said plurality of track crossings take place during said final approach stage.

3. Method according to claim 1, wherein the calibration value (TESC) is calculated as an approximation of the average of said plurality of tracking error signal amplitudes (TESA(i)).

4. Method according to claim 3, wherein a calibration maximum (Cmax) is calculated as an approximation of the average of the maximum values of said plurality of tracking error signal amplitudes (TESA(i)), wherein a calibration minimum (Cmin) is calculated as an approximation of the average of the minimum values of said plurality of tracking error signal amplitudes (TESA(i)), and wherein the calibration value (TESC) is calculated as the difference between the calibration maximum and the calibration minimum (TESC=Cmax−Cmin).

5. Method according to claim 4, wherein the actual maximum values of said plurality of tracking error signal amplitudes (TESA(i)) are measured and stored, wherein the actual minimum values of said plurality of tracking error signal amplitudes (TESA(i)) are measured and stored, and wherein the calibration maximum (Cmax) and the calibration minimum (Cmin) are calculated on the basis of a predetermined number (N) of stored values from memory, N being larger than 1, N preferably being in the order of 10 or more.

6. Method according to claim 1, wherein the calibration value (TESC) is updated after each track crossing by increasing the calibration value (TESC) if the tracking error signal amplitude corresponding to the most recent track crossing is larger than the current value of the calibration value (TESC) or by decreasing the calibration value (TESC) if the tracking error signal amplitude corresponding to the most recent track crossing is smaller than the current value of the calibration value (TESC).

7. Method according to claim 1, wherein a calibration maximum (Cmax) is calculated depending on the maximum values of said plurality of tracking error signal amplitudes (TESA(i)), wherein a calibration minimum (Cmin) is calculated depending on the minimum values of said plurality of tracking error signal amplitudes (TESA(i)), and wherein the calibration value (TESC) is calculated as the difference between the calibration maximum and the calibration minimum (TESC=Cmax−Cmin).

8. Method according to claim 7, wherein, on sampling moments having a sampling frequency higher than the track crossing frequency, the calibration maximum (Cmax) is updated by increasing the calibration maximum (Cmax) if the current value of the tracking error signal (TES) is higher than the current value of the calibration maximum (Cmax), or the calibration maximum (Cmax) is updated by decreasing the calibration maximum (Cmax) if the current value of the tracking error signal (TES) is lower than the current value of the calibration maximum (Cmax);
and wherein, on sampling moments having a sampling frequency higher than the track crossing frequency, the calibration minimum (Cmin) is increased if the current value of the tracking error signal (TES) is higher than the current value of the calibration minimum (Cmin), or the calibration minimum (Cmin) is decreased if the current value of the tracking error signal (TES) is lower than the current value of the calibration minimum (Cmin).

9. Method according to claim 1, comprising the following steps:
a) starting a jump (step 301);
b) providing initial values (Cmax,i, Cmin,i) for a calibration maximum (Cmax) and a calibration minimum (Cmin), respectively (steps 302, 302);
c) providing addition and subtraction values (Δa, Δd) for the calibration maximum (Cmax), and providing addition and subtraction values (Δd, Δa) for the calibration minimum (Cmin);
d) providing a clock signal having a frequency higher than the track crossing frequency;
e) on sampling moments, determined by said clock signal:
e1) increasing the calibration maximum (Cmax) by the addition value (Δa) if the current value of the tracking error signal (TES) is higher than the current value of the calibration maximum (Cmax) (step 324);
e2) decreasing the calibration maximum (Cmax) by the subtraction value (Δd) if the current value of the tracking error signal (TES) is lower than the current value of the calibration maximum (Cmax) (step 323);
e3) decreasing the calibration minimum (Cmin) by the subtraction value (Δa) if the current value of the tracking error signal (TES) is lower than the current value of the calibration minimum (Cmin) (step 334);
e4) increasing the calibration minimum (Cmin) by the addition value (Δd) if the current value of the tracking error signal (TES) is higher than the current value of the calibration minimum (Cmin) (step 333);
f) calculating the calibration value (TESC) as the difference between the calibration maximum and the calibration minimum (TESC=Cmax−Cmin).

10. Method according to claim 9, wherein step e) is started only after the jump has reached the final approach stage with substantially constant track crossing speed.

11. Method according to claim 9, wherein the ratio of the addition value to the subtraction value is higher than 5:1, preferably at least 10:1.

12. Method according to claim 9, wherein the ratio of the sampling frequency to the track crossing frequency is higher than 5:1, preferably at least 10:1.

13. Method according to claim 9, wherein the ratio of the addition value to the calibration maximum/minimum is in the order of 100:8000.

14. Method for controlling a radial actuator (51) in an optical disc drive (1), the method comprising the steps of:
rotating an optical disc (2);
scanning a track of the rotating optical disc (2) by a focus spot (F) of a light beam (32);
receiving a reflected light beam (32d), reflected from the optical disc (2);
generating a read signal (S_{R}) representing the received light beam (32d);
calculating a tracking error signal (TES) on the basis of the read signal (S_{R});
performing a jump to a target track;
during the jump, calculating a calibration value (TESC) using the method according to claim 1;
entering a track following mode;
in the track following mode, calculating a normalized tracking error signal (TESN) on the basis of the tracking error signal (TES) and the calibration value (TESC);
generating a control signal (S_{CR}) for controlling the radial actuator (51) on the basis of the normalized tracking error signal (TESN).

15. Disc drive apparatus (1), adapted to perform the method according to claim 1.
